(19) United States
(12) Patent Application Publication
(10) Pub. No.: US 2011/0279836 A1
(43) Pub. Date: Nov. 17, 2011

(54) IMAGE PROCESSING APPARATUS AND IMAGE PROCESSING METHOD

(75) Inventors: Hiromitsu Nishikawa, Tokyo (JP); Takahiro Suzuki, Tokyo (JP); Susumu Shimbaru, Yokohama-shi (JP)

(73) Assignee: CANON KABUSHIKI KAISHA, Tokyo (JP)

(21) Appl. No.: 13/104,655

(22) Filed: May 10, 2011

(30) Foreign Application Priority Data
May 17, 2010 (JP) 2010-113491

(51) Int. Cl. G06K 15/02

(52) U.S. Cl. 358/1.9

(57) ABSTRACT

An image processing apparatus includes an acquisition unit configured to acquire a lightness distribution of an image which input image data represents, a generation unit configured to generate a gloss control signal for controlling a glossiness of the image, depending on the lightness distribution, and a conversion unit configured to convert the input image data into output image data, based on the gloss control signal.

### BACKGROUND OF THE INVENTION

1. Field of the Invention

The present invention relates to an image processing suitable for generation of signals for a printing apparatus.

2. Description of the Related Art

In a printer using pigment-based color materials, it is known that gloss characteristics are varied according to a reflectance of the pigment-based color materials and an amount adhering to a paper surface. This is because, unlike dye-based color materials, the pigment-based color materials remain on the paper surface, and as a result, a reflection which occurs on a surface of paper in the dye-based color materials, occurs on a surface of the pigment that covers the paper. In other words, for the printer using the pigment-based color materials, a control of the gloss is very important. For example, Japanese Patent No. 3591534 discusses a technique for enhancing uniformity of the gloss by combining colored ink and improved ink that contributes to the gloss.

However, sufficient uniformity of the gloss cannot be realized by the technique described in Japanese Patent No. 3591534 in some cases, depending on image data to be printed.

### SUMMARY OF THE INVENTION

The present invention is directed to providing image processing in which gloss control can be appropriately performed.

According to an aspect of the present invention, an image processing apparatus includes an acquisition unit configured to acquire a lightness distribution of an image which input image data represents, a generation unit configured to generate a gloss control signal for controlling a glossiness of the image, depending on the lightness distribution, and a conversion unit configured to convert the input image data into output image data, based on the gloss control signal.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a functional block diagram illustrating a configuration of an image processing apparatus according to a first exemplary embodiment of the present invention.

FIG. 2 illustrates an image brightness analysis unit and a gloss control signal generation unit.

FIG. 3 is a flowchart illustrating an operation of the image processing apparatus according to the first exemplary embodiment.

FIG. 4 illustrates a content of control of glossiness.

FIG. 5 is a flowchart illustrating an operation of an image processing apparatus according to a second exemplary embodiment.

FIGS. 6A and 6B illustrate a relationship between a total amount of color materials and their glossinesses.

FIGS. 7A, 7B, and 7C are views for explaining printing process using pigment-based color materials.

### DESCRIPTION OF THE EMBODIMENTS

Various exemplary embodiments, features, and aspects of the invention will be described in detail below with reference to the drawings.

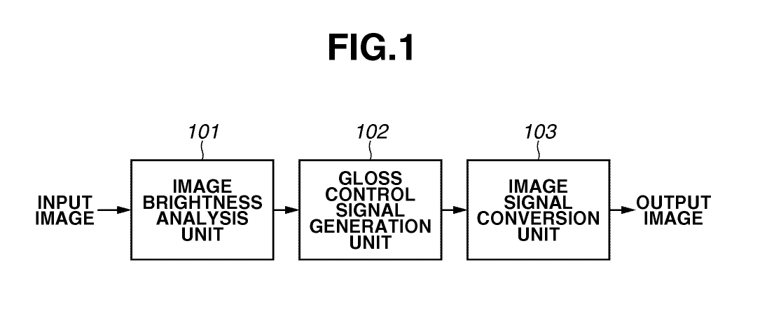

A first exemplary embodiment will be described. FIG. 1 is a functional block diagram illustrating a functional configuration of an image processing apparatus according to the first exemplary embodiment.

As illustrated in FIG. 1, the image processing apparatus according to the first exemplary embodiment is provided with an image brightness analysis unit 101 (an image analysis unit), a gloss control signal generation unit 102, and an image signal conversion unit 103. The image brightness analysis unit 101 analyzes especially a brightness of an image (input image) which input image data represents. The gloss control signal generation unit 102 generates a signal (gloss control signal) for controlling a gloss of an output image according to the brightness of the input image analyzed by the image brightness analysis unit 101 for each pixel of the image. The image signal conversion unit 103 converts the input image data into output image data, based on the gloss control signal generated by the gloss control signal generation unit 102, and color information of the input image.

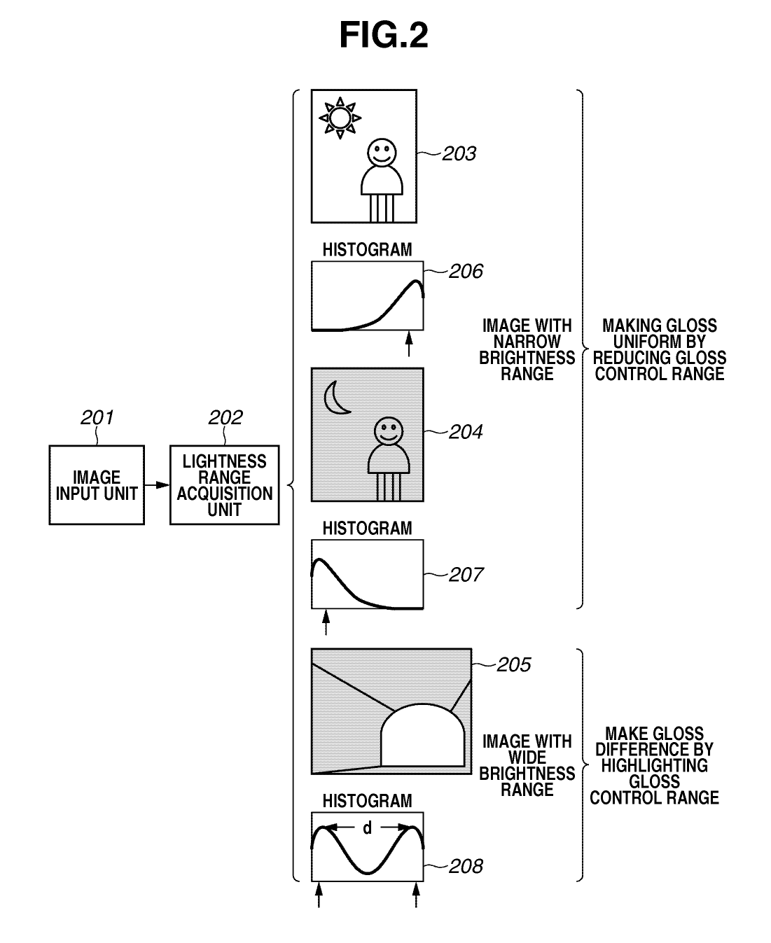

Next, the details of the image brightness analysis unit 101 and the gloss control signal generation unit 102 will be described. FIG. 2 illustrates configurations and operations of the image brightness analysis unit 101 and the gloss control signal generation unit 102.

As illustrated in FIG. 2, the image brightness analysis unit 101 includes an image input unit 201 and a lightness range acquisition unit 202. The image input unit 201 acquires input image data corresponding to an image from a storage medium or an information processing apparatus connected to the outside. The lightness range acquisition unit 202 analyzes a lightness distribution of the image by acquiring a range of lightness of the image represented by the input image data. In an analysis of the lightness distribution, for example, a histogram analysis is performed using histograms. More specifically, for example, with respect to an input image 203 photographed outdoors during the day the lightness range acquisition unit 202 creates a histogram 206 with a peak situated nearer a high luminance side, and performs analysis using the histogram 206, as illustrated in FIG. 2. In addition, for example, with respect to an input image 204 photographed outdoors during the night the lightness range acquisition unit 202 creates a histogram 207 with a peak situated nearer a low luminance side, and performs analysis using the histogram 207. Yet in addition, the lightness range acquisition unit 202 creates a histogram 208 with peaks existing both at the high luminance and the low luminance sides, and performs analysis using the histogram 208, with respect to, for example, an input image 205 photographed in a tunnel during the day.

Then, the gloss control signal generation unit 102 generates a gloss control signal that renders the gloss uniform with respect to the input image with a narrow range of brightness (lightness range) to such a degree that a peak of the histogram exists at gradations in a limited range. On the other hand, the lightness range acquisition unit 202 generates the gloss control signal so that a gloss difference is highlighted with respect to an input image with a wide lightness range, to such a degree that a peak of histogram exists at gradations in a wide range. More specifically, the lightness range acquisition unit 202 generates the gloss control signal that renders the gloss uniform, with respect to a high-key input image 203 and a low-key input image 204, as represented in, for example, the histogram 206 and the histogram 207. On the other hand, the lightness range acquisition unit 202 generates the gloss control signal that causes the gloss difference to be highlighted, with respect to the input image 205 in which a plurality of peaks exists at positions apart from each other, as represented in the histogram 208.

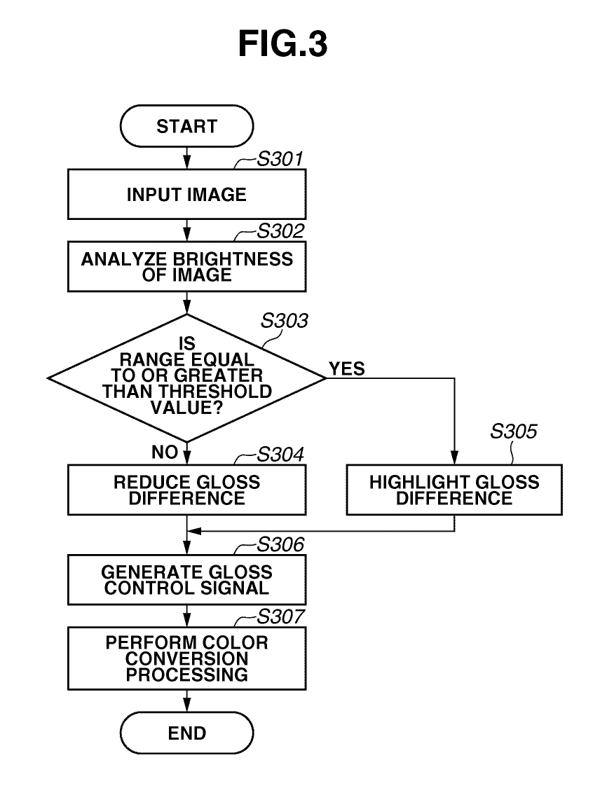

Next, an operation of the image processing apparatus configured as described above will be described. FIG. 3 is a flowchart illustrating an operation of the image processing apparatus according to the first exemplary embodiment. First, in step S301, the image input unit 201 of the image brightness analysis unit 101 acquires input image data. A format of the input image data is not restricted to a particular one and, for example, an red green blue (RGB) color specification system, a cyan magenta yellow black (CMYK) color specification system, an L*a*b* color specification system or an XYZ color specification system is used. The input image data is stored, for example, in a storage unit such as a random-access memory (RAM).

Then, in step S302, the lightness range acquisition unit 202 of the image brightness analysis unit 101 analyzes a brightness of the input image. At this time, the lightness range acquisition unit 202, as described above, performs, for example, histogram analysis. Then, the lightness range acquisition unit 202 analyzes whether the input image is an image with a narrow lightness range, like the input image 203 or 204, or an image with a wide lightness range, like the input image 205, and outputs the result.

Thereafter, in step S303, the gloss control signal generation unit 102 determines whether the lightness range is equal to or greater than a predefined threshold value, based on a result of the analysis by the lightness range acquisition unit 202. Then, if the lightness range is equal to or greater than the threshold value (YES in step S303), the processing proceeds to step S305. If not (NO in step S303), the processing proceeds to step S304. If a plurality of peaks exist in the lightness of the input image like, for example, the histogram 208, the gloss control signal generation unit 102 calculates a difference in lightness (lightness difference) “d” between the peaks, and may perform determination based on whether this is equal to or greater than the predefined threshold value. Furthermore, the gloss control signal generation unit 102 may perform determination based on whether the lightness range is equal to or greater than the threshold value, and the difference in lightness “d” is equal to or greater than the threshold value.

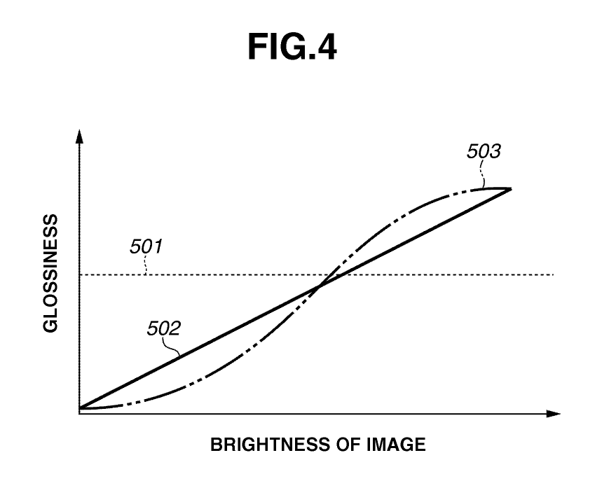

In step S304, the gloss control signal generation unit 102 determines to generate a gloss control signal for reducing a gloss difference between different brightnesses in the output image. FIG. 4 illustrates an example of the gloss control signal. In FIG. 4, it is assumed that a state where a glossiness which indicates an intensity of a gloss of the output image is proportional to a brightness of the input image is a normal state 502 and the state is indicated by a solid line. The gloss control signal for reducing a gloss difference which is a difference in glossiness is indicated by a function 501. In a state indicated by the function 501 as compared with the normal state 502, a glossiness of the output image becomes constant regardless of a brightness of the input image.

On the other hand, in step S305, the gloss control signal generation unit 102 determines to generate a gloss control signal for highlighting a gloss difference of the output image. In FIG. 4, the gloss control signal for highlighting the gloss difference is indicated by a function 503. A state indicated by the function 503 is represented by an “S”-shape curve which expresses a relationship of a glossiness of the output image with respect to a brightness of the input image. More specifically, it shows a curve which indicates convex downward at a lower lightness relative to a certain lightness, and indicates convex upward at a higher lightness.

Then, in step S306, the gloss control signal generation unit 102 generates the gloss control signal decided in step S304 or S305 as the function 501 and the function 503, based on the normal state 502. The gloss control signal may be generated with respect to, for example, all pixels, or the function 501 and the function 503 may be the ones which have been created in advance using a publicly known technique such as a spline function and stored in the gloss control signal generation unit 102.

Then, in step S307, the image signal conversion unit 103 converts, as color conversion processing, a signal of the input image acquired by the image input unit 201 into a signal of the output image, based on the gloss control signal generated by the gloss control signal generation unit 102. More specifically, the image signal conversion unit 103 performs color conversion processing for reducing a gloss difference, with respect to the input image in which a lightness range is less than the threshold value, like the input images 203 and 204, and performs color conversion processing for highlighting a gloss difference, with respect to the input image in which a lightness range is equal to or greater than the threshold value like the input image 205. In these color conversion processing, the image signal conversion unit 103 generates four-color output signals for a printing apparatus which performs, e.g., four-color printing of CMYK. Further, the image signal conversion unit 103 may generate not only four-color, but also six-color output signals for the printing apparatus which performs six-color printing of cyan magenta yellow black light-cyan light-magenta (CMYKLcLm). The details of the color conversion processing will be described below.

Hereinbelow, the details of color conversion processing of the image signal based on the gloss control signal will be described. In general, in a pigment-based ink printer, it is known that a correlation between a total amount of color materials to be used for image reproduction, and a glossiness is high, since the pigment-based color material remains on a recording medium surface.

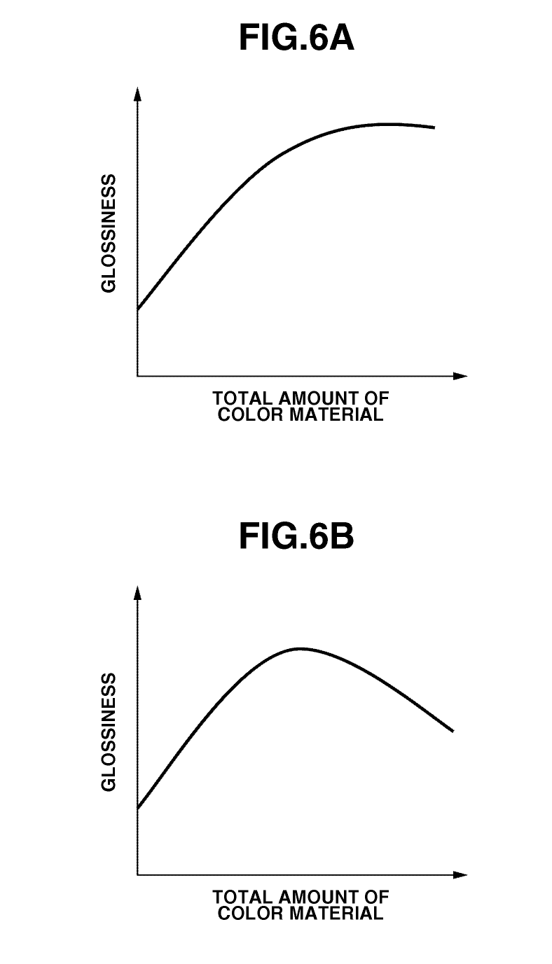

FIGS. 6A and 6B illustrate relationships between total amounts of color materials and their glossinesses, in the printer using general pigment-based color materials. The relationship illustrated in FIG. 6A, is an example of a printer which has a fixing process in an image forming process, like an electrophotographic printer or the like, which indicates that the glossiness becomes higher when the total amount of color materials is increased. The relationship illustrated in FIG. 6B, is an example of a printer which does not have the fixing process in the image forming process of a pigment-based inkjet printer or the like, in which a gloss becomes lower in the process where the total amount of color materials is increased.

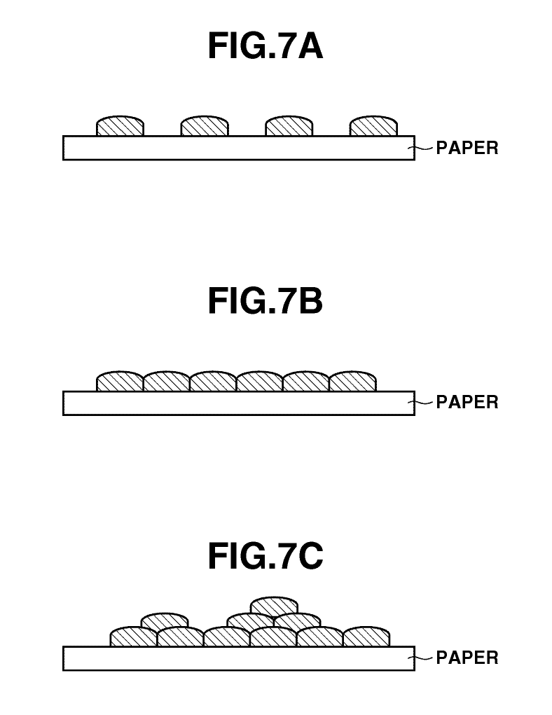

This is because the process goes through following states, namely, in a printing process of the pigment-based inkjet, a state where a non-print region and a print region coexists, as illustrated in FIG. 7A, a state where the entire recording region surface is the print region, and the total amount of color materials is relatively small, as illustrated in FIG. 7B, and a state where the entire recording region surface is the print region, and the total amount of color materials is relatively plenty, as illustrated in FIG. 7C. This is because, in a stage from FIG. 7A to FIG. 7B, the glossiness becomes higher depending on an area of the print region, and in a stage from FIG. 7B to FIG. 7C, a geometry of the recording region becomes convex-concave (i.e., rough), so that the glossiness becomes lower.

From the above descriptions, if there exists a plurality of combinations of color materials that can reproduce the identical color, out of combinations with the different total amounts of color materials, it is understood that a gloss can be controlled on the identical color. More specifically, for example, in FIG. 6A, if color conversion processing is performed on a combination of color materials into a high total amount of color materials, out of the combinations of color materials that can reproduce the identical color, it becomes possible to output an image with a high gloss. On the other hand, if color conversion processing is performed on a combination of color materials into a low total amount of color materials, then it becomes possible to output an image with a low gloss.

Now, as a method for color conversion processing for generating output signals with different total amounts of color materials in identical color reproduction, a publicly known technique such as an under color removal (UCR), or a gray component replacement (GCR) can be used. For example, if a black (K) amount is increased, then CMY amounts can be reduced, and accordingly a control can be made to decrease the total amount of color materials. Similarly, if the black (K) amount is decreased, then CMY amounts can be increased, and accordingly a control can be made to increase the total amount of color materials. Furthermore, in a printer having color materials with low densities such as light cyan (Lc), and light magenta (Lm), color conversion processing for generating output signals with different total amounts of color materials in identical color reproduction is possible, by controlling a combined amounts of cyan (C) and Lc, and a combined amounts of magenta (M) and Lm, which yield identical density.

Thus, in step S307, the output image data is obtained by color-converting the input image data acquired in step S301 into a combination of color materials having the glossiness corresponding to the gloss control signal generated in step S306. More specifically, with regard to a combination of plural sets of color materials, reproducible colors and glossinesses based on each combination are prepared in advance. By selecting a set which can reproduce the glossiness corresponding to the gloss control signal generated in step S306, the output signal with respect to each pixel of the input image data is obtained from among these plural sets.

If a set having a glossiness which coincides with the glossiness corresponding to the gloss control signal generated in step S306 does not exist in a plurality of sets prepared in advance, closest two sets are selected from among the sets prepared in advance, and the output signal may be determined by performing interpolation processing on each color material amount in the two selected sets. When the processing in step S307 is terminated, a series of processing will be completed. Recently, printing has been possible using colorless and transparent toner/ink or the like, without the need to change an amount of color material of colored ink, and it is also possible to increase a total amount of color materials by adding the colorless and transparent toner/ink. In other words, it is also possible to control a gloss to a higher level in a highlight region or the like where colored ink is small in amount.

According to the above first exemplary embodiment, a control of a gloss of the output image depending on a lightness range of the input image is performed, and as a result, the output image with higher reproducibility can be obtained. Therefore, if printing is performed using this output image, print image which exhibits a higher reality can be obtained, even when the pigment-based color materials are used.

The analysis performed by the lightness range acquisition unit 202 is not limited to a histogram analysis, but an analysis, for example, using a distribution of G channel of RGB images may be also performed. In this process, the reason for using the G channel, is that the G channel has the highest correlation with respect to change in luminance, compared with R, B channels, and a channel is not limited to the G channel as long as it has a high correlation.

The lightness range analyzed by the lightness range acquisition unit is not limited to two levels (S303), three or more levels may be used. In this case, similarly to steps S304 and S305, reduction and highlight in the gloss difference may be varied depending on the levels of the lightness range. In other words, it is only necessary to perform control so that the gloss difference is highlighted even more, when the lightness range becomes wider. For example, a function which has a gradient between a gradient which the function 501 indicates, and a gradient of a straight line which represents a state 502, may be created. Alternatively, a plurality of gamma values expressing “S” shape representing the function 503 may be provided. Alternatively, in step S305, individual controls such as only bright section control, or only dark section control may be performed, in place of the control by the function 503.

Alternatively, in step S306, with regard to images which make no difference in glosses, configuration for keeping the uniform control signals together may be used, or they may be grouped depending on the image distribution. Alternatively, they may be varied in accordance with hardware constraints such as a memory of the system. Alternatively, signals output by the color conversion processing in step S307 are not necessarily the ones for four-color print, and signals for other color numbers may be used. For example, they may be signals for a material containing, at least three colored materials, and at least one colorless gloss control material, and signals for control of a printer (image output apparatus).

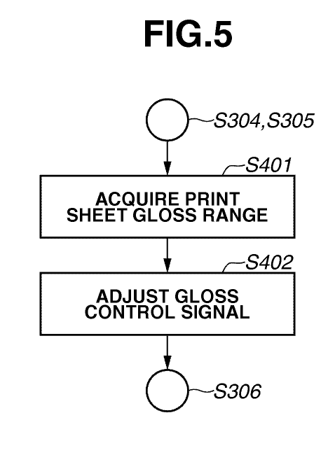

Next, a second exemplary embodiment will be described. The second exemplary embodiment differs from the first exemplary embodiment on the point that processing for further controlling the gloss is performed between step S304 or S305 and step S306. Other configurations and operations are similar to those in the first exemplary embodiment. FIG. 5 is a flowchart illustrating an operation of the image processing apparatus according to the second exemplary embodiment. In the second exemplary embodiment, first, similarly to the first exemplary embodiment, the processing in steps S301 to S305 is performed.

Then, in step S401, after the processing in step S304 or S305 has been performed, the gloss control signal generation unit 102 acquires information relating to glossiness of a print sheet (print medium) on which printing is performed, based on the output image. A user may input the information through, for example, a user interface, and in a case where a sensor for detecting a glossiness of the print sheet is provided in the printing apparatus, the glossiness may be detected using this sensor.

Thereafter, in step S402, the gloss control signal generation unit 102 determines a content of control for further adjusting gloss differences, based on information relating to the glossiness acquired in step S401 and a result of the analysis (in step S302) by the lightness range acquisition unit 202. For example, if the processing in step S305 has been performed, when the print sheet has a stronger glossiness, the gloss control signal generation unit 102 weakens a degree of adjustment (S-shape) from the straight line of state 502, with respect to the function 503 in FIG. 4, thus approaching the state 502. On the other hand, when the print sheet has a weaker glossiness, the gloss control signal generation unit 102 determines a content of control to strengthen a degree of adjustment (S-shape) from the straight line of the state 502.

Subsequently, similarly to the first exemplary embodiment, the gloss control signal generation unit 102 performs processing in steps S306 and S307. According to the second exemplary embodiment, since a gloss control of the output image is performed in consideration of not only a lightness range of the input image, but also a glossiness of the print sheet, an output image with even higher reproducibility can be obtained.

Each step of the above-described exemplary embodiment can be also realized by causing a processing apparatus (a central processing unit (CPU), processor) such as a personal computer to execute software (program) acquired via a network or various types of storage media. Further, in a case where the image processing apparatus in the above-described exemplary embodiment is realized as the printer, the output image data converted in step S307, may be printed on the print medium by a recording unit of the printing apparatus. According to the above-described exemplary embodiment, a control adapted to an image is performed, and as a result, a gloss can be appropriately reproduced.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-113491 filed May 17, 2010, which is hereby incorporated by reference herein in its entirety.

What is claimed is:

1. An image processing apparatus comprising:
an acquisition unit configured to acquire a lightness distribution of an image which input image data represents;
a generation unit configured to generate a gloss control signal for controlling a glossiness of the image, depending on the lightness distribution; and
a conversion unit configured to convert the input image data into output image data, based on the gloss control signal.

2. The image processing apparatus according to claim 1, wherein the acquisition unit creates a histogram of the image, and analyzes a lightness range which is a range of brightness of the image based on the histogram.

3. The image processing apparatus according to claim 2, wherein, if a plurality of peaks of the histogram exists, the lightness distribution is a lightness difference between the peaks.

4. The image processing apparatus according to claim 2, wherein the generation unit generates the gloss control signal that controls the conversion unit to convert the image data into the output image data which highlights a gloss difference in the image as the lightness range becomes wider.

5. The image processing apparatus according to claim 2, wherein the generation unit generates the gloss control signal that controls the conversion unit to convert the image data into the output image data which highlights a gloss difference in the image as the lightness range is wider, and highlights a gloss difference in the image as a glossiness of a print medium on which the output image data is printed, is weaker.

6. The image processing apparatus according to claim 1, wherein the input image data is expressed by RGB color specification system, L*a*b* color specification system or XYZ color specification system.

7. The image processing apparatus according to claim 1, wherein signals of the output image data are signals of materials containing at least three colored materials, and at least one colorless gloss control material, and are signals for control of an image output apparatus.

8. The image processing apparatus according to claim 1, further comprising:
a recording unit configured to record an image on a print medium using the output image data converted by the conversion unit.

9. An image processing method comprising:
acquiring a lightness distribution of an image which input image data represents; and
generating a gloss control signal for controlling a glossiness of the image, depending on the lightness distribution; and
converting the input image data into output image data, based on the gloss control signal.

10. A computer-readable storage medium that stores a program that causes a computer to function as each unit of the image processing apparatus according to claim 1.
